(19) United States
(12) Patent Application Publication
(10) Pub. No.: US 2019/0080258 A1
(43) Pub. Date: Mar. 14, 2019

(54) OBSERVATION HUB DEVICE AND METHOD

(71) Applicant: Intel Corporation, Santa Clara, CA (US)

(72) Inventors: Patrik Eder, Taufkirchen (DE); Christian Horak, Vaterstetten (DE); Joseph F. Cramer, Austin, TX (US)

(21) Appl. No.: 15/703,149

(22) Filed: Sep. 13, 2017

(51) Int. Cl. G06N 99/00; G06N 5/02; G06N 3/02

(52) U.S. Cl. CPC G06N 99/005; H04W 84/042; G06N 3/02; G06N 5/022

(57) ABSTRACT

Embodiments of the present disclosure may relate to an apparatus with an observation hub that includes a machine-learning model, where the observation hub is to determine a state of an apparatus based at least in part on the machine-learning model and trace data received from one or more trace sources, and alter an operating condition of the apparatus based at least in part on the determined state of the apparatus. Embodiments may also include a multi-buffer trace unit to change one or more of a sort rule, a trigger rule, an enforcement rule, or a filter rule of the multi-buffer trace unit based at least in part on the determined state of the apparatus. Other embodiments may be described and/or claimed.

### FIELD

Embodiments of the present disclosure generally relate to the field of debugging a device under test (DUT) and, more particularly, to debugging a DUT that processes streams of trace data.

### BACKGROUND

Legacy trace and observation techniques for debugging a device under test (DUT) such as a modem in a mobile device typically rely on post processing and analysis performed in a manual manner outside the DUT. This imposes resource issues and limits the debug ability of a system as not all relevant data can be exported in all situations.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 depicts a block diagram of an apparatus that includes an observation hub, in accordance with various embodiments.

FIG. 2 depicts a block diagram of a debug framework for a device under test that includes an observation hub, in accordance with various embodiments.

FIG. 3 is a flow diagram of a technique of debugging a device under test that includes an observation hub, in accordance with various embodiments.

FIG. 4 is a block diagram of a computing device, in accordance with various embodiments.

FIG. 5 is a block diagram that schematically illustrates a computing device, in accordance with various embodiments.

FIG. 6 illustrates an example storage medium with instructions configured to enable an apparatus to practice various aspects of the present disclosure, in accordance with various embodiments.

### DETAILED DESCRIPTION

Embodiments of the present disclosure may relate to a an apparatus with an observation hub (OSH) that includes a machine-learning (ML) model, where the OSH is to determine a state of an apparatus based at least in part on the ML model and trace data received from one or more trace sources, and alter an operating condition of the apparatus based at least in part on the determined state of the apparatus. Embodiments may also include a multi-buffer trace (MBT) unit to change one or more of a sort rule, a trigger rule, an enforcement rule, or a filter rule of the MBT unit based at least in part on the determined state of the apparatus. In some embodiments, the apparatus with the OSH may be or include a device under test (DUT).

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

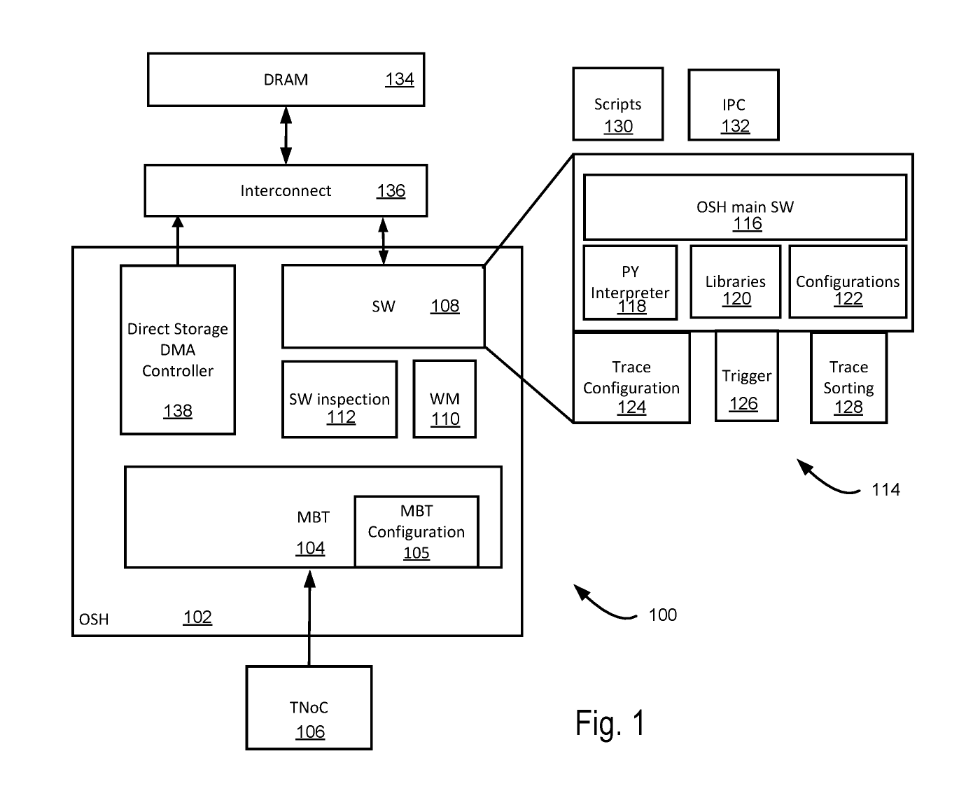

FIG. 1 depicts a block diagram of an apparatus 100 that may include an observation hub (OSH) 102, in accordance with various embodiments. In some embodiments, the OSH 102 may be or include a trace handling hub for debugging the apparatus 100 and may also be used for non-debug observation tasks such as device sanity checks by using embedded information in trace data and/or other environmental parameters (e.g., voltage levels, CPU load, and/or temperature). In various embodiments, the apparatus 100 and/or some portion thereof being trained and/or debugged may also be referred to as a DUT.

In some embodiments, the OSH 102 may be included in a system-on-chip (SoC). In some embodiments, the OSH 102 may include a multi-buffer trace unit (MBT) 104 that may include an MBT configuration 105. In some embodiments, the MBT 104 may be referred to as a trace sorting unit or the OSH 102 may include a trace sorting unit instead of or in addition to the MBT 104. In various embodiments, a trace network fabric (TNoC) 106 may provide trace data from one or more components (e.g., trace sources) of the apparatus 100, not shown for clarity. In some embodiments, a trace backbone (not shown for clarity) may provide the trace data instead of, or in addition to, the TNoC 106, with the trace backbone combining the trace data from the trace sources into a stream toward the OSH 102. In some embodiments, the one or more trace sources may be included on an SoC with the OSH 102. In some embodiments, the SoC may include a wireless communications modem that may include one or more of the trace sources. In various embodiments, the apparatus 100 may be or be included in a mobile computing apparatus that may include, coupled with the SoC, a display, a touchscreen display, a touchscreen controller, a battery, a global positioning system device, a compass, a speaker, or a camera. In some embodiments, one or more components of the apparatus 100 (e.g., the OSH 102) may include one or more processors, application specific integrated circuits (ASICs), state machines, controllers, switches and/or other circuit logic, field programmable gate arrays (FPGAs), firmware, and/or software that may implement one or more functions of components in the apparatus 100. In some embodiments, one or more components of the apparatus 100 may be a part of, or act as a part of, an adaptive control loop. In some embodiments, the apparatus 100 may extend beyond a localized DUT to include a system with one or more remote network components and/or one or more infrastructure components of a communications system.

In some embodiments, the MBT 104 may receive trace data from the TNoC 106. In various embodiments, the apparatus 100 may include one or more trace sources that may generate or otherwise provide trace data that describes or otherwise indicates a state of the trace source and/or a state of circuitry associated with the trace source. In some embodiments, the trace sources may reside in or on the same integrated circuit (IC) chip as the OSH 102. In other embodiments, one or more trace sources may be located in or on different IC chips (e.g., in different packaged devices of the same platform). In various embodiments, trace sources may include a modem, a bus, a processor core, a memory region, a controller, a power management circuit, and/or any other circuit component. In some embodiments, trace data output by a particular trace source may include data describing or otherwise indicating a current state of that particular trace source. In various embodiments, such trace data may be subsequently evaluated (e.g., in combination with other trace data from the same trace source and/or trace data from one or more other trace sources) to perform diagnostics, troubleshooting, and/or other system evaluation processes. In some embodiments, the trace data from the trace sources may be provided to the OSH 102 over the TNoC 106, which may be a trace data fabric or any other suitable trace data network. In various embodiments, the apparatus 100 may act in a client or a server based application. In some embodiments, the OSH 102 may be used to provide data for use by a server or to another OSH. In various embodiments, one or more parameters used by one or more OSH may be remotely received.

In various embodiments, the MBT 104 may include a first level of data processing between the TNoC 106 and local processing blocks of the OSH 102. In some embodiments, filtering (e.g., message drop and/or sorting) may occur in the MBT 104. In some embodiments, the TNoC 106 may suppress unneeded data (e.g., through control by the OSH 102). Suppression of unneeded data by the TNoC 106 may provide for a more distributed processing approach that may allow the MBT 104 and/or other components of the OSH 102 to perform sorting of only relevant data without performing an evaluation of whether the data is needed. In various embodiments, this distributed processing approach may reduce the processing complexity of the OSH 102 and may reduce power consumption in that only data to be processed would travel across the TNoC 106.

In some embodiments, the MBT unit 104 may include one or more buffers and may store trace data to different buffers based on rules that may correspond to attributes associated with the trace data from the trace sources. In various embodiments, a rule may refer to information that defines or otherwise indicates a correspondence of a particular action with a respective condition (e.g., an event or state such as a data attribute) where the rule may require that the action is to take place in response to an instance of the corresponding condition. In some embodiments, an action required by a rule may include, for example, a buffering of trace data in a buffer of the MBT unit 104, a debuffering of trace data from a buffer of the MBT unit 104, and/or otherwise altering an operating condition of the apparatus 100. In various embodiments, the action may be specific to only a subset of different trace data types (e.g., where the action is to buffer or debuffer only trace data that has or is otherwise associated with a particular attribute). In some embodiments, a condition (e.g., for a rule corresponding to a particular action) may include a Boolean combination of multiple conditions. In some embodiments, debuffering may refer to moving data out of a buffer of the MBT unit 104.

In various embodiments, the rules may include sort rules, trigger rules, enforcement rules, filter rules and/or any other type of suitable rule (e.g., rules indicating a target to which the MBT is to send trace data). In some embodiments, the rules may be stored in the MBT configuration 105. In various embodiments, sort rules may indicate, for each buffer of a plurality of buffers of the MBT 104, one or more respective trace data attributes that correspond to that buffer. In some embodiments, trigger rules may indicate, for each trace data attribute of a plurality of trace data attributes, a respective condition that is to trigger a debuffering of trace data associated with that attribute. In various embodiments, enforcement rules may define or otherwise indicate a condition under which enforcement of a target rule or profile is to automatically commence or automatically stop. In some embodiments, filter rules may define or otherwise indicate a condition for message removal or deletion.

In various embodiments, the OSH 102 may include software (SW) 108. In some embodiments, the OSH 102 may include a weighting matrix (WM) 110 and a SW inspection component 112. In various embodiments, the WM 110 may include weighting parameters that may be for an artificial neural network (ANN) or any other suitable type of ML model. In some embodiments, the OSH 102 may include a ML model with additional and/or other components than the WM 110. In some embodiments, the ML model (e.g., with WM 110) may be coupled with the MBT unit 104. In various embodiments, the WM 110 may be implemented with hardware, software, or some combination thereof.

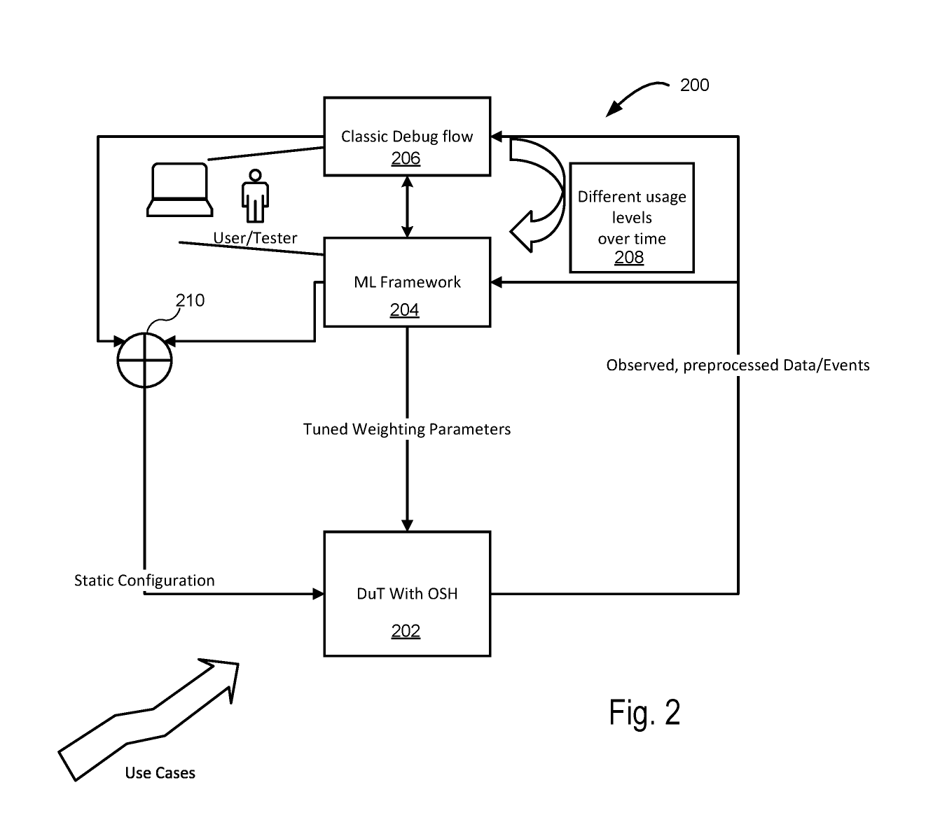

In some embodiments, the WM 110 may be a purpose built computation matrix for simple, predictable data structures or traces with limited data variance and size (e.g., a packetized digital audio data stream with only addition and multiplication logic applied to the data stream). In some embodiments, the values for the addition or multiplication factors may be selected from a current combination of MID/CID/TA. In various embodiments, an external framework (e.g., an external ML framework such as ML framework 204 of FIG. 2) may implement a full classifying environment including rule discovery and/or deep learning strategies, while the OSH 102, including the WM 110 may implement correlation and/or pattern matching hardware to react to rules previously found by the external framework that were promulgated to the OSH 102 (e.g., by updating the WM 110). In such embodiments, the learning may occur outside the DUT, but the OSH 102 may still be capable of more complex scenario detection (e.g., by using a prebuilt convolutional network) than in embodiments having a simple computation matrix directed to simple, predictable data structures or traces. In some embodiments, the external ML framework may optimize the network (e.g., convolutional network or other ANN) size and/or depth to the hardware capabilities of the OSH 102. In some embodiments, the WM 110 and/or other components of the DUT including the OSH 102 may include an entire ML framework, including rule finding and/or interpretation engines. In some embodiments, a software defined ANN may be included in the DUT with OSH 102 and/or may be included in one or more external data center devices (e.g., ANN on a cloud computing network) accessible to the DUT with OSH 102 and may extend the complexity of debug coverage. In various embodiments, the SW 108 may include SW components 114 that may include OSH main SW 116, a python (PY) interpreter 118, one or more libraries 120, and one or more configurations 122. In some embodiments, the SW components 114 may include an interpreter of program routines changeable by a user at any time (e.g., formulated in the python programming language) instead of, or in addition to the PY interpreter 118. In some embodiments, the SW components 114 may also include a trace configuration component 124, a trigger component 126, and/or a trace sorting component 128. In other embodiments, one or more of the trace configuration component 124, the trigger component 126, and/or the trace sorting component 128 may be included in the MBT 104, and may implement sorting, trigger, enforcement, and/or other rules of the MBT 104. In some embodiments, one or more components of the OSH 102 may be implemented by a cloud computing environment, and/or may receive data from the cloud that may be temporally based (e.g., traffic conditions, a temporary system loading, temperature conditions, or other externally derivable metrics) that may be used as inputs for one or more operations performed by the OSH 102, and/or may assist in adaptive filtering or ML.

In various embodiments, the OSH 102 may determine a state of the apparatus 100 and/or detect a change in state of the apparatus 100 based at least in part on a ML model (e.g., WM 110) and trace data received from one or more trace sources (e.g., via TNoC 106). In some embodiments, the OSH 102 may determine a state of the apparatus 100 and/or detect a change in state of the apparatus 100 also based at least in part on the SW inspection component 112. In some embodiments, where a state may be clearly determined based on a simple parameter (e.g., a predefined temperature threshold is exceeded indicating an impending failure state), the state may be determined based at least in part on the SW inspection component 112 without using the WM 110. In some embodiments, the trace data may include one or more key performance indicators (e.g., a message rate per second indicator for one or more time intervals). In some embodiments, determining a state of the apparatus 100 may include predicting a future state of the apparatus 100 (e.g., a crash state). In various embodiments, the OSH 102 may also identify a source of the predicted future state based at least in part on the ML model. In some embodiments, the detected change in state may be a change in apparatus 100 connectivity from a first type of wireless network (e.g., a third generation (3G) network) to a second type of wireless network (e.g., a fourth generation (4G) network or a fifth generation (5G) network).

In some embodiments, the OSH 102 may alter an operating condition of the apparatus 100 based at least in part on the determined state of the apparatus 100, the detected change in state of the apparatus 100, and/or the identified source of the predicted future state. In some embodiments, altering an operating condition of the apparatus 100 may include altering operation of the apparatus 100 to prevent a predicted future state (e.g., to prevent a predicted crash state). In various embodiments, the OSH 102 may change one or more of a sort rule, a trigger rule, an enforcement rule, a filter rule, or some other rule of the MBT configuration 105 based at least in part on the determined state of the apparatus 100. In some embodiments, the OSH 102 may perform one or more of buffering or debuffering trace data based at least in part on the one or more changed sort rule, trigger rule, enforcement rule, filter rule, or other rule of the MBT configuration 105.

In some embodiments, one or more scripts 130 may interact with the OSH 102. In various embodiments, the OSH 102 may use one or more interprocess communication (IPC) interfaces 132 to communicate with one or more other components, processes, and/or devices. In some embodiments, the OSH 102 may store and/or retrieve data in one or more memory devices such as a dynamic random access memory (DRAM) 134 over an interconnect 136. In various embodiments, the OSH 102 may include a direct storage path to DRAM 134 that may include a direct memory access (DMA) controller 138. In some embodiments, the DRAM 134 may be external to the apparatus 100. In other embodiments, the DRAM 134 may be a part of the apparatus 100. In various embodiments, one or more other types of data storage, not shown for clarity, may be used instead of or in addition to the DRAM 134 and may be a part of the apparatus 100 or external to the apparatus 100.

In various embodiments, the MBT 104 may sort trace data in relation to one or more targets that may be in the form of a direct path to the DRAM 134 (e.g., via the direct storage DMA controller 138), a SW path that may allow for flexible package inspection (e.g., SW inspection component 112), a ML model (e.g., WM 110) that may be configured to generate events based at least in part on learning from internal flows and/or an external DUT framework, or any other suitable target. In some embodiments, the MBT 104 may send trace data to one or more of the targets based at least in part on data in the MBT configuration 105. In some embodiments, the path to the DRAM 134 may only store data needed in failure cases to extend the debug information coverage in such situations. In some embodiments, the SW path for flexible package inspection may be scripted to inspect trace package content (e.g., with scripts 130) and/or may react based on non-hardware fixed events. In various embodiments, the WM 110 may allow correlation of traces based on learnings from previous traces by applying ML (e.g., ANN) techniques. In some embodiments, the WM 110 may be or include a correlation engine for previously seen failure cases and may assist the OSH 102 in separating known issues and detecting new behavior of the apparatus 100. In some embodiments, correlation and/or signature recognition by the WM 110 may be implementation specific with respect to a type of data processed in relation to a traced function. In some embodiments, one or more state machines may be used for signature recognition and/or correlation of traces.

In various embodiments, the MBT 104 may take inputs from the TNoC 106 and/or other debug data sources and may filter and/or sort messages (e.g., trace data) to different destinations that may be changeable by user, scripting, and/or weighting matrix events. In some embodiments, the sorted data may be written to the WM 110, scripted SW, and/or directly to DRAM 134. In various embodiments, the MBT 104 may be controlled by registers, wires, and/or any other suitable technique. In some embodiments, sorting may be performed by inspection of sideband information on a source and/or type of message. In some embodiments, in-depth payload processing may not be performed at the sorting stage.

In some embodiments, in addition to hardware supported functionality, the OSH 102 may include a dynamic scriptable SW path (e.g., SW inspection component 112 driven by scripts 130 and PY interpreter 118). In some embodiments, an OSH 102 user may have an option of processing data without recompiling any part of the SW 108. In various embodiments, the SW 108 may include an application programming interface (API) that may support trace configuration 124, setup of WM 110, event handling, access to machine libraries 120, and any other suitable function. In some embodiments, the API may offer an interface to any presented components of the OSH 102.

In some embodiments, the OSH 102 may include debug control over a scripting interface. In various embodiments, the OSH 102 may be able to take over debug communication from any interface and interact with one or more debug structures. In some embodiments, this may provide for an abstraction of debug hardware onto a more software driven, abstract interface (e.g., commands from a debugger such as GDB over universal asynchronous receiver/transmitter (UART)). In various embodiments, a programmable core of the SW 108 may be secured by allowing only execution of signed images such that the debug function may be firewalled and may offer a higher level of security on systems where debug functionality cannot be switched off entirely, without the need for an extensive hardware solution beyond securing debug after Power on Reset. In some embodiments, having a programmable core controlling the debug function of the rest of the system may also provide features such as debug over Ethernet or other interfaces without hardware changes.

FIG. 2 depicts a block diagram of a debug framework 200 for a device under test (DUT) 202 (e.g., some or all of apparatus 100 of FIG. 1) that includes an observation hub (e.g., OSH 102 of FIG. 1), in accordance with various embodiments. In some embodiments, the debug framework 200 may include a path through a machine learning (ML) framework 204. In various embodiments, the debug framework 200 may also include a path through a classic debug flow 206 (e.g., during a training of the ML framework of block 204 and/or the WM 110 of FIG. 1). In some embodiments, training and/or development of the ML framework 204 may be performed with one or more use cases (e.g., test conditions) that result in trace data being generated by one or more trace sources in the DUT 202.

In some embodiments, the path through the classic debug flow 206, interaction between the classic debug flow 206 and the ML framework 204, the user/tester, and use of different usage levels over time 208 may only be present during a training and/or a DUT development phase such that only the path through the ML framework 204 may be present and implemented in an apparatus (e.g., apparatus 100) that includes the OSH (e.g., OSH 102) and a ML model (e.g., WM 110). In various embodiments, the debug framework 200 may include a combination block 210 where results from the classic debug flow 206 and/or the ML framework 204 may be combined to generate updates to a static configuration for the DUT 202. In some embodiments where one of the classic debug flow 206 or the ML framework 204 is not active, updates to the static configuration for the DUT 202 may be generated from the results of only one of the classic debug flow 206 or the ML framework 204 at the combination block 210.

In various embodiments, the classic debug flow 206 may be used to fine tune an inner loop (e.g., through the ML framework 204) to train the ML framework 204 to detect failures and other operating states on the DUT 202 itself rather than manually post processing exported data. In some embodiments, over time, the data export rate from the DUT 202 may be reduced and the DUT 202 may export high bandwidth data only for previously unseen issues.

In various embodiments, the observed, preprocessed data/events from the DUT 202 may be trace data (e.g., from the DRAM 134). In some embodiments, the tuned weighting parameters from the ML framework 204 may be used to update the WM 110. In various embodiments, the static configuration from the combination block 210 may be used to update the MBT 104 of the DUT 202 (e.g., by updating the MBT configuration 105). In some embodiments, the static configuration updates from the combination block 210 may include updates to sort rules, trigger rules, enforcement rules, filter rules, or any other suitable configuration of the MBT 104 or some other component of the DUT 202.

In various embodiments, moving the processing and evaluation of traces into the DUT 202 may allow for a flexible, low bandwidth technique to identify a root cause of issues that may arise during operation of the DUT 202. In some embodiments, as less data is exported from the DUT 202, the noisiness of the trace and debug process may be reduced. In some embodiments, various types of sensitive data may be sorted out, with only false data (e.g., invalid keys) being exported. In various embodiments, moving the processing and evaluation of traces into the DUT 202 may provide for early system crash detection and in some cases predicting device failure before an actual crash. In some embodiments, the OSH of the DUT 202 may be system aware (e.g., able to detect mismatches in the system derived from first level trace sources). In various embodiments, in response to detecting a particular mismatch, the OSH of the DUT 202 may be triggered to request a debug event prior to an actual failure. In some embodiments, this may include exporting relevant data to allow a debug user to investigate an issue as it happens such that an analysis may not need be performed post-crash. In some embodiments, events may be tagged for post-processing or signature recognition.

In some embodiments, the debug user may be removed from the loop and automated techniques may tune one or more correlation mechanisms such that the DUT 202 may employ self-healing techniques. In various embodiments, the self-healing techniques may include automated issue fixing by interpreting an upcoming failure, correlating it to known and/or solved issues, and applying measures stored in a database on the DUT 202 or in a remote machine-readable database that may be accessed by the DUT 202.

In some embodiments, before training of the DUT 202 begins, a ML flow through the ML framework 204 may not be in use and the classic debug flow 206 may be used for initial operations such as hardware validation of the DUT 202. In various embodiments, during a training phase, data may be captured via the classic debug flow 206, which may train the ML framework 204. In some embodiments, during the training phase, the ML framework 204 may still not be in use, such that the link between the ML framework 204 and the DUT with OSH 202 and/or the link between the ML framework 204 and the combination block 210 may not be present during the training phase. In various embodiments, the training phase may include reinforced learning based on known good and/or bad trace data, which may be referred to as golden traces in some embodiments. In various embodiments, the same data may be fed into both the WM 110 and the DMA controller 138. In some embodiments, the WM 110 may generate results based on the data, and the SW 108 may capture the results from the WM 110 and may send them to the ML framework 204 for further processing alongside the trace data. In various embodiments, the ML framework 204 may change the parameters of the WM 110 to train the DUT 202 to trigger on unexpected system behavior based at least in part on the parameters in the WM 110. In some embodiments, the MBT configuration 105 may be a static configuration during this initial training phase. During the training phase, the traces themselves may continue to be exported and processed with the classic debug flow 206.

In various embodiments, training progress may be tracked, and once the ML framework 204 reaches a tolerable error rate, the ML framework 204 may be transitioned onto the DUT 202. In some embodiments, the ML framework 204 may be transitioned onto the DUT 202 in a first DUT development phase where both the classic debug flow 206 and the ML framework 204 may operate in parallel. In various embodiments, during the first DUT development phase, the ML hardware (e.g., WM 110) on the DUT 202 may not be active, with the ML framework 204 only being used to fine tune data generation. In some embodiments, during the first DUT development phase, the link between the ML framework 204 and the combination block 210 may be present. In various embodiments, during a second DUT development phase, the ML hardware (e.g., WM 110) in the DUT 202 may be activated to influence configuration of data generation in a dynamic fashion, based on captured content. In some embodiments, during the second DUT development phase, exported data (e.g., to the classic debug flow 206) may be filtered such that identified data content and/or system events are not exported, and only unexpected data content and/or system events are exported to the classic debug flow 206.

In various embodiments, during the first and/or second DUT development phase, real world trace data may be fed into the WM 110 and the DMA controller 138. In some embodiments, the real world trace data may correspond to one or more use cases and/or operating conditions. In various embodiments, the SW 108 may be triggered by the WM 110 and, depending on the nature of the trigger, may reconfigure the MBT configuration 105 and/or send events to one or more upper layers in response to the triggering by the WM 110. In some embodiments, the MBT configuration 105 may be a dynamic and/or adapting configuration during these phases. In some embodiments, the events may include an observed or detected issue and/or an observed or detected non-expected data flow. In various embodiments, during the second development phase, both the WM 110 and the SW inspection component 112 may be active. In some embodiments, the same trace data may be fed into both the WM 110 and the DMA controller 138. In various embodiments, the MBT 104 may be programmed and/or configured to selectively feed traces into a path that includes the SW inspection component 112 (e.g., to handle known corner cases that may not be trainable to the WM 110). In some embodiments, the SW 108 may be triggered by patterns via the WM 110 or the SW inspection component 112, and the SW 108 may reconfigure the MBT configuration 105 and/or send events to upper layers based at least in part on the triggering. In some embodiments, the MBT configuration 105 may be a dynamic and/or adapting configuration during this phase.

In various embodiments, during an implementation phase, the classic debug flow 206 may no longer be in use. In some embodiments, during the implementation phase, the user/tester and/or the classic debug flow 206 may not be present, with the observed, preprocessed data/events from the DUT 202 flowing only to the ML framework 204. In some embodiments, during the implementation phase, the ML framework 204 may be used for system monitoring, debugging, and/or basic DUT health monitoring, and may not export data unless a communication is explicitly requested and allowed by security and/or privacy rules. In some embodiments, ML inside the DUT 202 may allow for a debug process on the DUT 202 itself.

In various embodiments, manual work may be removed from data processing steps, allowing a higher degree of automation on root cause finding. In some embodiments, this may include closing the external loop that includes the classic debut flow 206 such that it is no longer present, by including ML capabilities on the DUT 202. In various embodiments, some, or all, of the ML framework 204 may be present on the DUT 202 rather than external to the DUT 202. In some embodiments where the ML framework 204 is included on the DUT 202, a full ANN may be included on the DUT 202 rather than a weighting only WM 110, the DUT 202 may include a self-hosted processing framework, and/or the DUT 202 may include a data environment that supports storage of large amounts of data inside the DUT 202. In some embodiments, a scalable approach may be used to adapt implemented hardware and/or software to the DUT 202 (e.g., by using a small WM in internet of things (IoT) appliances and a full neural network in server class devices). In some embodiments, where the ML framework 204 is included on the DUT 202, the DUT 202 may encompass the ML framework 204 and/or the combination block 210. In some embodiments, where the ML framework 204 is included on the DUT 202, the DUT 202 may include components for higher layer on-board computation (e.g., a CPU cluster) to handle processing for the ML framework 204.

In various embodiments, the DUT 202 may include a full ANN, including all learning capabilities. In some embodiments, some aspects of the ANN may not be included on the DUT 202 (e.g., due to one or more resource constraints in a mobile DUT) and only a data weighting matrix (e.g., WM 110) portion of a ML model may be implemented on a SoC of the DUT 202. In some embodiments, the WM 110 may perform first level signature recognition while other machine learning processes and/or generation of weighting parameters for the WM may occur outside the SoC and/or outside the DUT 202 (e.g., in ML Framework 204). In various embodiments, the WM 110 may be statically configured after it has been trained but may still allow for detection of complex scenarios with respect to the DUT 202 without human interaction. In other embodiments, the WM 110 may be dynamically configured and may continue to be updated by processes internal to the DUT 202 (e.g., other components of a ML model) or external to the DUT (e.g., ML Framework 204). In some embodiments, the DUT 202 may learn from a previous run that ended in a core dump with limited data available and may allow a second run to enable a full debug trace before a core dump or post mortem data collection is triggered to give the system and/or a user additional data around a failure point even in cases where the root cause of the issue may not be known. In some embodiments, a pattern of data gained in a first run may be used to trigger additional data output before tracing a root cause in a second run.

In various embodiments, a number of golden patterns (e.g., known good and/or known bad patterns) may be set by default in the WM 110. In some embodiments, the golden patterns may allow the DUT 202 to react in advance of potential failures based on past learning. In some embodiments, data processing by the WM 110 may be performed with one or more observed parameters that may include continuous tracking of messages that may be event generated (e.g., a time invariant key performance indicator (KPI) such as message rate/second exceeded), correlation of messages accumulated in a predefined time period (e.g., once per Long Term Evolution (LTE) slot), and/or accumulation of a specific number of messages my source combinations (e.g., correlation of a handover from Third Generation Wireless (3G) to LTE to a golden pattern). In various embodiments, the WM 110 may be used for platform state detection, a comparison against an assumed state, trace enablement based on device history, trace reconstruction, and/or any other suitable debugging or monitoring. In some embodiments, the DUT 202 may weight traces per time interval (e.g., by radio access technology (RAT) slot or timing advance (TA) frequency), may detect possible failures based on signature recognition of captured traces, may adapt trace verbosity (e.g., based on received signal strength indicator (RSSI) levels or overall system load), and or may include any other suitable working mode.

In some embodiments, debugging and/or verification of the DUT 202 may change during a lifetime of the DUT 202. At first, in some embodiments, the flow may be roughly similar to legacy approaches that do not include the ML framework 204 where all debug data may be exported and processed outside the DUT 202. In some embodiments, after an issue is captured and a root cause has been traced, a user (e.g., user/tester) may, depending on the cause of the error, either generate a script (e.g., for simple detection scenarios such as a single isolated event structure) and may store the script in scripts 130, or may apply machine learning techniques to the generated trace data (e.g., flow of failure understood but not tracked to a single isolated event structure). In various embodiments, with the ML approach, a correlation matrix may be formed that matches to the specific event. In some embodiments, the parameters from the correlation matrix may be loaded onto the DUTs WM (e.g., WM 110) that may use the parameters to detect additional events when trace data is processed with the WM. Then, in some embodiments, when the DUT 202 detects an event with the WM, the DUT 202 may not send out as much trace data as it had previously, but may generate and send out a small message indicating the occurrence of the detected event (e.g., using SW 108). In some embodiments, in situations where the failure is detected but a root cause has not been completely determined (e.g., an infrequent crash triggering event), the debug flow may continue to evaluate a source of the failure, but with less information export flow due to a reduced need for debug data outside the DUT 202. In some embodiments, the DUT may send out an amount of debug data that corresponds to a severity level of a detected issue (e.g., additional data may be sent out for issues having a higher severity level than those having lower severity levels). In various embodiments, following machine learning and training of the DUT WM, traces may vanish on repetitive assertion of a learned failure event.

In various embodiments, during the training phase, first development phase, and/or second development phase, more than one DUT 202 may be used to train and/or develop the ML framework 204. In some embodiments where more than one DUT with OSH 202 is used to train the ML framework 204, the ML model on the DUTs (e.g., WM 110) may be updated and/or tuned based at least in part on one or more parameters learned from scenarios that may have occurred on a different DUT 202. In some embodiments, trace data from multiple DUTs may be collected in big data appliances (e.g., machine learning frameworks running on cloud servers) and may link captured data to causes and/or data sources using trace data from the multiple DUTs (e.g. call drops may be correlated to severe weather conditions such as a lightning strike in a specific area). In some embodiments that use multiple DUTs as data sources, the DUTs may include a basic, weighting only WM implementation and an externally hosted processing framework (e.g., ML framework 204) may be used to train the WMs on the DUTs. In some embodiments, cloud-based big data (e.g., data aggregated from multiple DUTs) and/or statistical learning may also be used to train and/or develop the ML framework 204.

In various embodiments, moving debug flows away from the classic debug flow 206 involving a user/tester may reduce costs and may result in a less time consuming debug flow. Additionally, in some embodiments, exporting less trace data may reduce the visibility of the internal state of the DUT 202 to outside observers, improving the security of the DUT 202, data privacy, and reducing the feasibility of some types of attacks on the DUT 202.

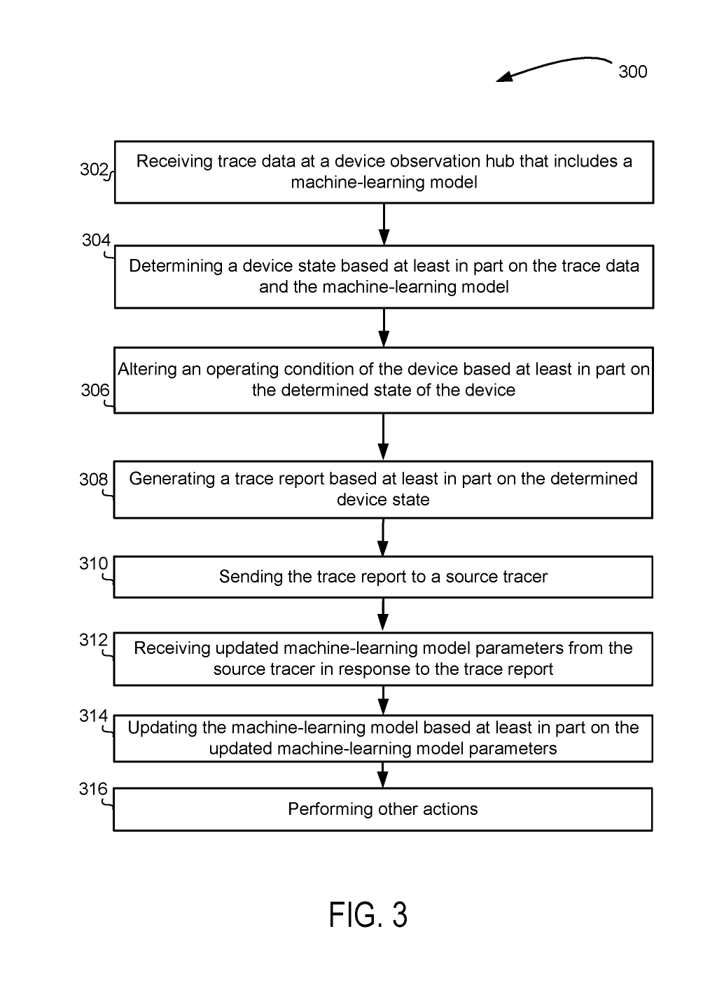

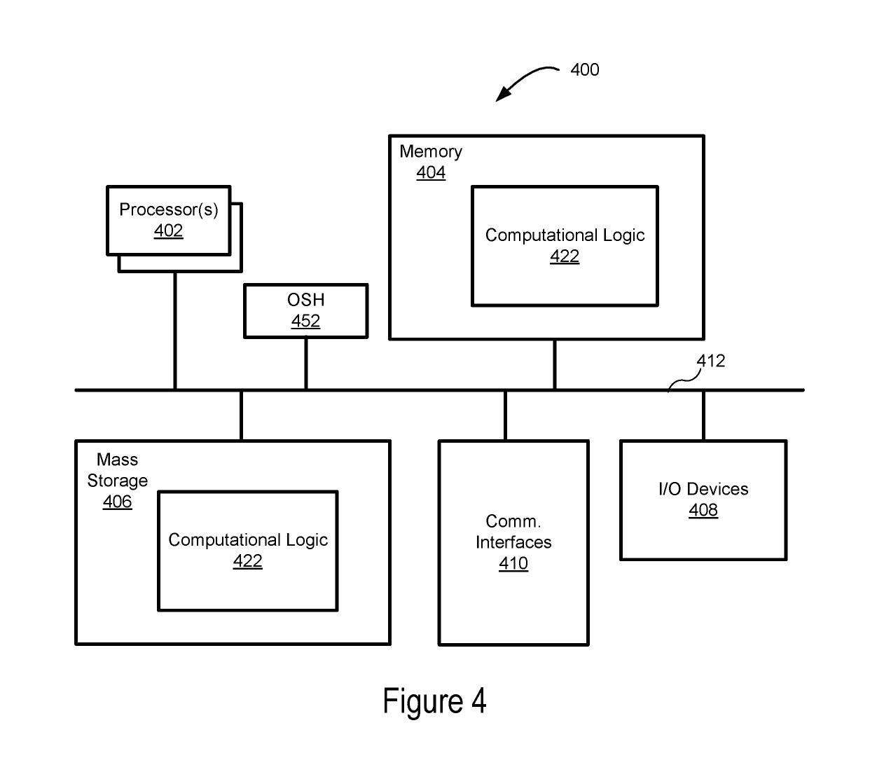

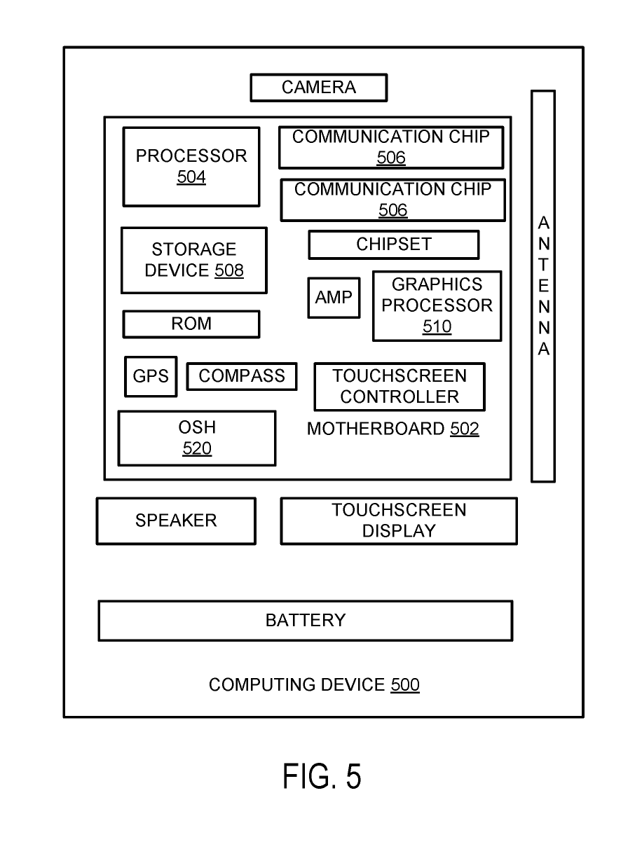

FIG. 3 is a flow diagram of a technique 300 of debugging a device under test that includes an observation hub (e.g., OSH 102 of FIG. 1), in accordance with various embodiments. In some embodiments, some or all of the technique 300 may be practiced by components shown and/or described with respect to the apparatus 100 of FIG. 1, the DUT 202 of FIG. 2, the ML framework 204 of FIG. 2, the computing device 400 of FIG. 4, the computing device 500 of FIG. 5, or some other component described with respect to FIGS. 1-2 and/or FIGS. 4-5.

In various embodiments, at a block 302, the technique 300 may include receiving trace data (e.g., from TNoC 106) at a device observation hub (e.g., OSH 102) that includes a machine-learning model (e.g., a machine learning model that includes the WM 110). In some embodiments, the trace data may include a message rate per second indicator for one or more time intervals. At a block 304, the technique 300 may include determining a device state based at least in part on the trace data and the machine-learning model. In some embodiments, determining the device state at the block 304 may include predicting a future device state and/or detecting a change in device state. In some embodiments, at a block 306, the technique 300 may include altering an operating condition of the device based at least in part on the determined state of the device. In some embodiments, if it is determined at the block 304 that a predicted future device state is a crash state, altering an operating condition at the block 306 may include altering operation of the device to prevent the predicted future device state. In some embodiments, the technique 300 may include identifying a source of the predicted crash state based at least in part on the machine-learning model, and altering operation of the device may be based at least in part on the identified source of the predicted crash state. In some embodiments, at a block 308, the technique 300 may include generating a trace report based at least in part on the determined device state. At a block 310, the technique 300 may include sending the trace report to a source tracer in some embodiments. In some embodiments, at a block 312, the technique 300 may include receiving updated machine-learning model parameters from the source tracer in response to the trace report. At a block 314, the technique 300 may include updating the machine-learning model based at least in part on the updated machine-learning model parameters. In some embodiments, at a block 316, the technique 300 may include performing other actions such as, for example, receiving second trace data at a second time after receiving the updated machine-learning model parameters, determining, by the device observation hub, a second device state based at least in part on the second trace data and the updated machine-learning model, and altering an operating condition of the device based at least in part on the determined second device state.

FIG. 4 illustrates a block diagram of an example computing device 400 suitable for use with various components of FIG. 1-2, and the technique 300 of FIG. 3, in accordance with various embodiments. For example, the computing device 400 may be, or may include or otherwise be coupled to, apparatus 100, OSH 102, TNoC 106, DRAM 134, interconnect 136, DUT 202, and/or ML Framework 204. As shown, computing device 400 may include one or more processors or processor cores 402 and system memory 404. For the purpose of this application, including the claims, the terms “processor” and “processor cores” may be considered synonymous, unless the context clearly requires otherwise. The processor 402 may include any type of processors, such as a central processing unit (CPU), a microprocessor, and the like. The processor 402 may be implemented as an integrated circuit having multi-cores, e.g., a multi-core microprocessor. The computing device 400 may include mass storage devices 406 (such as diskette, hard drive, non-volatile memory (e.g., compact disc read-only memory (CD-ROM), digital versatile disk (DVD), and so forth). In general, system memory 404 and/or mass storage devices 406 may be temporal and/or persistent storage of any type, including, but not limited to, volatile and non-volatile memory, optical, magnetic, and/or solid state mass storage, and so forth. Volatile memory may include, but is not limited to, static and/or dynamic random access memory (DRAM). Non-volatile memory may include, but is not limited to, electrically erasable programmable read-only memory, phase change memory, resistive memory, and so forth.

The computing device 400 may further include I/O devices 408 (such as a display (e.g., a touchscreen display), keyboard, cursor control, remote control, gaming controller, image capture device, and so forth) and communication interfaces 410 (such as network interface cards, modems, infrared receivers, radio receivers (e.g., Bluetooth), and so forth).

The communication interfaces 410 may include communication chips (not shown) that may be configured to operate the device 400 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 410 may operate in accordance with other wireless protocols in other embodiments. In various embodiments, computing device may include an OSH 452 that may be configured in similar fashion to the OSH 102 described with respect to FIG. 1. In some embodiments, the OSH 452 may be coupled with other components of the computer device 400.

The above-described computing device 400 elements may be coupled to each other via system bus 412, which may represent one or more buses. In the case of multiple buses, they may be bridged by one or more bus bridges (not shown). Each of these elements may perform its conventional functions known in the art. In particular, system memory 404 and mass storage devices 406 may be employed to store a working copy and a permanent copy of the programming instructions for the operation of various components of computing device 400, including but not limited to an operating system of computing device 400 and/or one or more applications. The various elements may be implemented by assembler instructions supported by processor(s) 402 or high-level languages that may be compiled into such instructions.

The permanent copy of the programming instructions may be placed into mass storage devices 406 in the factory, or in the field through, for example, a distribution medium (not shown), such as a compact disc (CD), or through communication interface 410 (from a distribution server (not shown)). That is, one or more distribution media having an implementation of the agent program may be employed to distribute the agent and to program various computing devices.

The number, capability, and/or capacity of the elements 408, 410, 412 may vary, depending on whether computing device 400 is used as a stationary computing device, such as a set-top box or desktop computer, or a mobile computing device, such as a tablet computing device, laptop computer, game console, or smartphone. Their constitutions are otherwise known, and accordingly will not be further described.

In embodiments, memory 404 may include computational logic 422 configured to implement various firmware and/or software services associated with operations of the computing device 400. For some embodiments, at least one of processors 402 may be packaged together with computational logic 422 configured to practice aspects of embodiments described herein to form a System in Package (SiP) or a System on Chip (SoC).

In various implementations, the computing device 400 may comprise one or more components of a data center, a laptop, a netbook, a notebook, an ultrabook, a smartphone, a tablet, a personal digital assistant (PDA), an ultra mobile PC, a mobile phone, or a digital camera. In some embodiments, the computing device 400 include one or more components of an internet of things (IoT) device or a smart clothing device. In various embodiments, the computing device 400 may include adaptive or ML tracing to save power. In further implementations, the computing device 400 may be any other electronic device that processes data.

FIG. 5 schematically illustrates a computing device 500 that may include the apparatus 100 of FIG. 1, the OSH 102 of FIG. 1, the DUT 202 of FIG. 2, and/or the computing device 400 of FIG. 4, in accordance with various embodiments. The computing device 500 may be, for example, an AR headset, a VR headset, a mobile communication device or a desktop or rack-based computing device. The computing device 500 may house a board such as a motherboard 502. The motherboard 502 may include a number of components, including (but not limited to) a processor 504 and at least one communication chip 506.

The computing device 500 may include a storage device 508 that may be coupled with the processor 504 and/or other components of the computing device 500. In some embodiments, the storage device 508 may include one or more solid state drives. Examples of storage devices that may be included in the storage device 508 include volatile memory (e.g., dynamic random access memory (DRAM)), non-volatile memory (e.g., read-only memory, ROM), flash memory, and mass storage devices (such as hard disk drives, compact discs (CDs), digital versatile discs (DVDs), and so forth).

Depending on its applications, the computing device 500 may include other components that may or may not be physically and electrically coupled to the motherboard 502. These other components may include, but are not limited to, a graphics processor 510, a digital signal processor, a crypto processor, a chipset, an antenna, a display, a touchscreen display, a touchscreen controller, a battery, an audio codec, a video codec, a power amplifier, a global positioning system (GPS) device, a compass, a Geiger counter, an accelerometer, a gyroscope, a speaker, and a camera.

The communication chip 506 and the antenna may enable wireless communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible broadband wireless access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 506 may operate in accordance with a Global System for Mobile Communications (GSM), General Packet Radio Service (GPRS), Universal Mobile Telecommunications System (UMTS), High Speed Packet Access (HSPA), Evolved HSPA (E-HSPA), or LTE network. The communication chip 506 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 506 may operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication chip 506 may operate in accordance with other wireless protocols in other embodiments. In various embodiments, the communication chip 506 may operate in accordance with one or more third generation partnership project (3GPP) standardized networks (e.g., 3G, 4G, 5G, and beyond (e.g., 6G)) and/or similar wireless networks.

The computing device 500 may include a plurality of communication chips 506. For instance, a first communication chip 506 may be dedicated to shorter range wireless communications such as Wi-Fi and Bluetooth, and a second communication chip 506 may be dedicated to longer range wireless communications such as GPS, EDGE, GPRS, CDMA, WiMAX, LTE, EV-DO, and others. In some embodiments, the communication chip 506 may support wired communications. For example, the computing device 500 may include one or more wired servers.

The processor 504 and/or the communication chip 506 of the computing device 500 may include one or more dies or other components in an IC package. Such an IC package may be coupled with an interposer or another package. The term “processor” may refer to any device or portion of a device that processes electronic data from registers and/or memory to transform that electronic data into other electronic data that may be stored in registers and/or memory. In various embodiments, the computing device 500 may include an OSH 520 that may correspond to the OSH 102 of FIG. 1, an OSH in the DUT 202 of FIG. 2, and/or the OSH 452 of FIG. 4. In some embodiments, the OSH 520 may be coupled with the processor 504 and/or other components, connections not shown for clarity. In some embodiments, the computing device 500 may include one or more of the components or a subset of the components shown in FIG. 5.

In various implementations, the computing device 500 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 500 may be any other electronic device that processes data and includes or is communicatively coupled with an OSH in accordance with embodiments described herein.

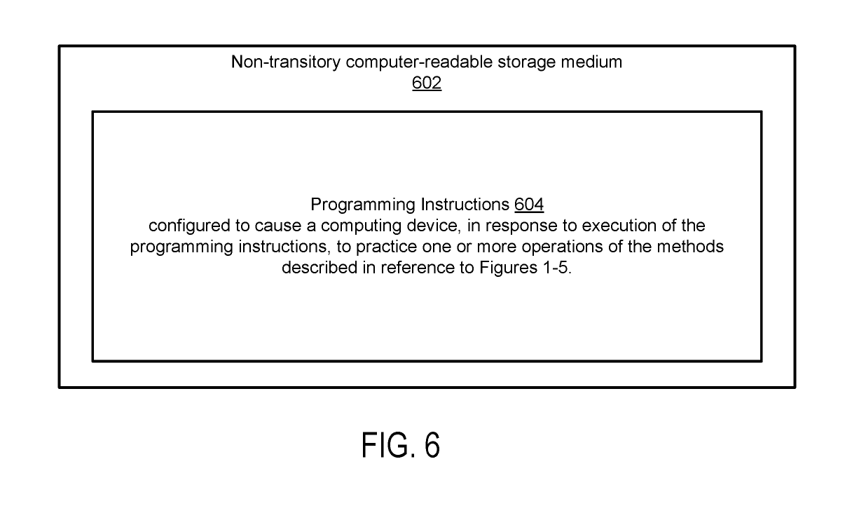

FIG. 6 illustrates example computer-readable storage medium 602 having instructions configured to practice all or selected ones of the operations associated with the computer device 400, earlier described with respect to FIG. 4; the apparatus 100 and/or the OSH 102 described with respect to FIG. 1; the DUT 202 and/or the ML Framework 204 described with respect to FIG. 2; the computer device 500, including OSH 520, described with respect to FIG. 5; and/or the technique 300 of FIG. 3, in accordance with various embodiments. As illustrated, computer-readable storage medium 602 may include a number of programming instructions 604. The storage medium 602 may represent a broad range of non-transitory persistent storage medium known in the art, including but not limited to flash memory, dynamic random access memory, static random access memory, an optical disk, a magnetic disk, etc. Programming instructions 604 may be configured to enable a device, e.g., computer device 400, apparatus 100, OSH 102, DUT 202 and/or computer device 500 in response to execution of the programming instructions 604, to perform, e.g., but not limited to, various operations described for the MBT 104, the SW 108, SW inspection component 112, the WM 110, the ML Framework 204, the computer device 400 of FIG. 4, the computer device 500 of FIG. 5 or operations shown and/or described with respect to technique 300 of FIG. 3. In alternate embodiments, programming instructions 604 may be disposed on multiple computer-readable storage media 602. In alternate embodiment, storage medium 602 may be transitory, e.g., signals encoded with programming instructions 604.

Referring back to FIG. 4, for an embodiment, at least one of processors 402 may be packaged together with memory having all or portions of computational logic 422 configured to practice aspects shown or described for the apparatus 100 shown in FIG. 1, DUT 202 and/or ML Framework 204 of FIG. 2, or operations shown or described with respect to technique 300 of FIG. 3. For an embodiment, at least one of processors 602 may be packaged together with memory having all or portions of computational logic 622 configured to practice aspects described for the apparatus 100 shown in FIG. 1, DUT 202 and/or ML Framework 204 of FIG. 2, or operations shown or described with respect to technique 300 of FIG. 3 to form a System in Package (SiP). For an embodiment, at least one of processors 402 may be integrated on the same die with memory having all or portions of computational logic 422 configured to practice aspects described for the apparatus 100 shown in FIG. 1, DUT 202 and/or ML Framework 204 of FIG. 2, or operations shown or described with respect to technique 300 of FIG. 3. For an embodiment, at least one of processors 402 may be packaged together with memory having all or portions of computational logic 422 configured to practice aspects of the apparatus 100 shown in FIG. 1, DUT 202 and/or ML Framework 204 of FIG. 2, or operations shown or described with respect to technique 300 of FIG. 3 to form a System on Chip (SoC).

Machine-readable media (including non-transitory machine-readable media, such as machine-readable storage media), methods, systems and devices for performing the above-described techniques are illustrative examples of embodiments disclosed herein. Additionally, other devices in the above-described interactions may be configured to perform various disclosed techniques.

### EXAMPLES

Example 1 may include an apparatus comprising: one or more trace sources; and an observation hub (OSH) coupled with the one or more trace data sources, wherein the OSH includes a machine-learning model and the OSH is to: determine a state of the apparatus based at least in part on the machine-learning model and trace data received from the one or more trace sources; and alter an operating condition of the apparatus based at least in part on the determined state of the apparatus.

Example 2 may include the subject matter of Example 1, wherein the machine-learning model includes a weighting matrix.

Example 3 may include the subject matter of Example 2, wherein the weighting matrix includes weighting parameters for an artificial neural network.

Example 4 may include the subject matter of any one of Examples 1-3, wherein the OSH includes a multi-buffer trace (MBT) unit coupled with the machine-learning model and the OSH is to change one or more of a sort rule, a trigger rule, an enforcement rule, or a filter rule of the MBT based at least in part on the determined state of the apparatus.

Example 5 may include the subject matter of Example 4, wherein the OSH is further to perform one or more of buffering or debuffering the trace data based at least in part on the one or more changed sort rule, trigger rule, enforcement rule, or filter rule.

Example 6 may include the subject matter of any one of Examples 1-5, wherein the one or more trace sources and the OSH are included in a system on a chip (SoC).

Example 7 may include the subject matter of Example 6, wherein the SoC includes a wireless communications modem that includes the one or more trace sources.

Example 8 may include the subject matter of any one of Examples 6-7, wherein the apparatus is a mobile computing apparatus including, coupled with the SoC, a display, a touchscreen display, a touchscreen controller, a battery, a global positioning system device, a compass, a speaker, or a camera.

Example 9 may include a method comprising: receiving trace data at a device observation hub that includes a machine-learning model; determining, by the device observation hub, a device state based at least in part on the trace data and the machine-learning model; and altering an operating condition of the device based at least in part on the determined state of the device.

Example 10 may include the subject matter of Example 9, wherein the machine-learning model includes a weighting matrix.

Example 11 may include the subject matter of Example 10, wherein the weighting matrix includes weighting parameters for an artificial neural network.

Example 12 may include the subject matter of any one of Examples 9-11, wherein determining, by the device observation hub, a device state, includes predicting a future device state.

Example 13 may include the subject matter of Example 12, wherein, in response to the predicted future device state is a crash state, altering an operating condition of the device includes altering operation of the device to prevent the predicted future device state.

Example 14 may include the subject matter of Example 13, wherein the method further includes identifying a source of the predicted crash state based at least in part on the machine-learning model, and wherein altering operation of the device is based at least in part on the identified source of the predicted crash state.

Example 15 may include the subject matter of any one of Examples 9-14, wherein the trace data includes a message rate per second indicator for one or more time intervals.

Example 16 may include the subject matter of any one of Examples 9-15, wherein the method further includes generating a trace report based at least in part on the determined device state, sending the trace report to a source tracer, receiving updated machine-learning model parameters from the source tracer in response to the trace report, and updating the machine-learning model based at least in part on the updated machine-learning model parameters.

Example 17 may include the subject matter of any one of Examples 9-16, wherein the trace data is first trace data received at a first time, the device state is a first device state, and the method further includes: receiving second trace data at a second time after receiving the updated machine-learning model parameters; determining by the device observation hub, a second device state based at least in part on the second trace data and the updated machine-learning model; and altering an operating condition of the device based at least in part on the determined second device state.

Example 18 may include one or more non-transitory computer-readable media comprising instructions that cause an apparatus, in response to execution of the instructions by the apparatus, to: determine, with an observation hub that includes a machine-learning model, a state of the apparatus based at least in part on trace data from one or more components of the apparatus and the machine-learning model; and alter an operating condition of the apparatus based at least in part on the determined state of the apparatus.

Example 19 may include the subject matter of Example 18, wherein the instructions are also to cause the apparatus to detect a change in state of the apparatus based at least in part on the trace data and the machine-learning model, and alter the operating condition of the apparatus based at least in part on the change in state.

Example 20 may include the subject matter of Example 19, wherein detecting the change in state includes detecting a change in apparatus connectivity from a first type of wireless network to a second type of wireless network.

Example 21 may include the subject matter of Example 20, wherein the first type of wireless network is a third generation (3G) wireless network.

Example 22 may include the subject matter of any one of Examples 18-21, wherein the instructions are to cause the apparatus to alter one or more of a buffering or a debuffering of trace data based at least in part on the determined state of the apparatus.

Example 23 may include the subject matter of any one of Examples 18-22, wherein the instructions are to cause the apparatus to change one or more of a sort rule, a trigger rule, an enforcement rule, or a filter rule of a multi-buffer trace unit based at least in part on the determined state of the apparatus.

Example 24 may include the subject matter of any one of Examples 18-23, wherein the instructions are to cause the apparatus to predict a future apparatus state based at least in part on the machine-learning model and the trace data.

Example 25 may include the subject matter of Example 24, wherein, in response to a prediction that the future apparatus is a crash state, the instructions are also to cause the apparatus to identify a source of the predicted crash state based at least in part on the machine-learning model, and alter operation of the apparatus based at least in part on the identified source to prevent the predicted crash state.

Example 26 may include an apparatus comprising: means for receiving trace data for a device; means for determining a device state based at least in part on the trace data and a machine-learning model; and means for altering an operating condition of the device based at least in part on the determined state of the device.

Example 27 may include the subject matter of Example 26, wherein the machine-learning model includes a weighting matrix.

Example 28 may include the subject matter of Example 27, wherein the weighting matrix includes weighting parameters for an artificial neural network.

Example 29 may include the subject matter of any one of Examples 26-28, wherein the means for determining a device state includes means for predicting a future device state.

Example 30 may include the subject matter of Example 29, wherein, in response to the predicted future device state is a crash state, the means for altering an operating condition of the device is to alter operation of the device to prevent the predicted future device state.

Example 31 may include the subject matter of Example 30, further comprising means for identifying a source of the predicted crash state based at least in part on the machine-learning model, wherein the means for altering an operating condition of the device is also to alter operation of the device based at least in part on the identified source of the predicted crash state.

Example 32 may include the subject matter of any one of Examples 26-31, wherein the trace data includes a message rate per second indicator for one or more time intervals.

Example 33 may include the subject matter of any one of Examples 26-32, further comprising: means for generating a trace report based at least in part on the determined device state; means for sending the trace report to a source tracer; means for receiving updated machine-learning model parameters from the source tracer in response to the trace report; and means for updating the machine-learning model based at least in part on the updated machine-learning model parameters.

Example 34 may include the subject matter of any one of Examples 26-33, wherein the trace data is first trace data received at a first time, the device state is a first device state, and the apparatus further includes: means for receiving second trace data at a second time after receiving the updated machine-learning model parameters; means for determining a second device state based at least in part on the second trace data and the updated machine-learning model; and means for altering an operating condition of the device based at least in part on the determined second device state.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

We claim:

1. An apparatus comprising:
one or more trace sources; and
an observation hub (OSH) coupled with the one or more trace sources, wherein the OSH includes a machine-learning model and the OSH is to:
determine a state of the apparatus based at least in part on the machine-learning model and trace data received from the one or more trace sources; and
alter an operating condition of the apparatus based at least in part on the determined state of the apparatus.

2. The apparatus of claim 1, wherein the machine-learning model includes a weighting matrix.

3. The apparatus of claim 2, wherein the weighting matrix includes weighting parameters for an artificial neural network.

4. The apparatus of claim 1, wherein the OSH includes a multi-buffer trace (MBT) unit coupled with the machine-learning model and the OSH is to change one or more of a sort rule, a trigger rule, an enforcement rule, or a filter rule of the MBT based at least in part on the determined state of the apparatus.

5. The apparatus of claim 4, wherein the OSH is further to perform one or more of buffering or debuffering the trace data based at least in part on the one or more changed sort rule, trigger rule, enforcement rule, or filter rule.

6. The apparatus of claim 1, wherein the one or more trace sources and the OSH are included in a system on a chip (SoC).

7. The apparatus of claim 6, wherein the SoC includes a wireless communications modem that includes the one or more trace sources.

8. The apparatus of claim 6, wherein the apparatus is a mobile computing apparatus including, coupled with the SoC, a display, a touchscreen display, a touchscreen controller, a battery, a global positioning system device, a compass, a speaker, or a camera.

9. A method comprising:
receiving trace data at a device observation hub that includes a machine-learning model;
determining, by the device observation hub, a device state based at least in part on the trace data and the machine-learning model; and
altering an operating condition of the device based at least in part on the determined state of the device.

10. The method of claim 9, wherein the machine-learning model includes a weighting matrix.

11. The method of claim 10, wherein the weighting matrix includes weighting parameters for an artificial neural network.

12. The method of claim 9, wherein determining, by the device observation hub, a device state, includes predicting a future device state.

13. The method of claim 12, wherein, in response to the predicted future device state is a crash state, altering an operating condition of the device includes altering operation of the device to prevent the predicted future device state.

14. The method of claim 13, wherein the method further includes identifying a source of the predicted crash state based at least in part on the machine-learning model, and wherein altering operation of the device is based at least in part on the identified source of the predicted crash state.

15. The method of claim 9, wherein the trace data includes a message rate per second indicator for one or more time intervals.

16. The method of claim 9, wherein the method further includes generating a trace report based at least in part on the determined device state, sending the trace report to a source tracer, receiving updated machine-learning model parameters from the source tracer in response to the trace report, and updating the machine-learning model based at least in part on the updated machine-learning model parameters.

17. The method of claim 9, wherein the trace data is first trace data received at a first time, the device state is a first device state, and the method further includes:
receiving second trace data at a second time after receiving the updated machine-learning model parameters;
determining by the device observation hub, a second device state based at least in part on the second trace data and the updated machine-learning model; and
altering an operating condition of the device based at least in part on the determined second device state.

18. One or more non-transitory computer-readable media comprising instructions that cause an apparatus, in response to execution of the instructions by the apparatus, to:
determine, with an observation hub that includes a machine-learning model, a state of the apparatus based at least in part on trace data from one or more components of the apparatus and the machine-learning model; and
alter an operating condition of the apparatus based at least in part on the determined state of the apparatus.

19. The one or more non-transitory computer-readable media of claim 18, wherein the instructions are also to cause the apparatus to detect a change in state of the apparatus based at least in part on the trace data and the machine-learning model, and alter the operating condition of the apparatus based at least in part on the change in state.

20. The one or more non-transitory computer-readable media of claim 19, wherein detecting the change in state includes detecting a change in apparatus connectivity from a first type of wireless network to a second type of wireless network.

21. The one or more non-transitory computer-readable media of claim 20, wherein the first type of wireless network is a third generation partnership project (3GPP) standardized wireless network.

22. The one or more non-transitory computer-readable media of claim 18, wherein the instructions are to cause the apparatus to alter one or more of a buffering or a debuffering of trace data based at least in part on the determined state of the apparatus.

23. The one or more non-transitory computer-readable media of claim 18, wherein the instructions are to cause the apparatus to change one or more of a sort rule, a trigger rule, an enforcement rule, or a filter rule of a multi-buffer trace unit based at least in part on the determined state of the apparatus.

24. The one or more non-transitory computer-readable media of claim 18, wherein the instructions are to cause the apparatus to predict a future apparatus state based at least in part on the machine-learning model and the trace data.

25. The one or more non-transitory computer-readable media of claim 24, wherein, in response to a prediction that the future apparatus is a crash state, the instructions are also to cause the apparatus to identify a source of the predicted crash state based at least in part on the machine-learning model, and alter operation of the apparatus based at least in part on the identified source to prevent the predicted crash state.
